(19) United States
(12) Patent Application Publication
(10) Pub. No.: US 2016/0189292 A1
(43) Pub. Date: Jun. 30, 2016

(54) PROGRAMMATIC SYSTEMS AND METHODS FOR LOAN UNDERWRITING FOR PREPAID ACCOUNTS

(71) Applicant: Green Dot Corporation, Pasadena, CA (US)

(72) Inventors: Alok Deshpande, Mountain View, CA (US); David Gullett, Pasadena, CA (US); Calvin Park, Pasadena, CA (US); Kuan Archer, Pasadena, CA (US)

(73) Assignee: Green Dot Corporation

(21) Appl. No.: 14/699,753

(22) Filed: Apr. 29, 2015

Related U.S. Application Data
(60) Provisional application No. 62/098,995, filed on Dec. 31, 2014.

(51) Int. Cl. G06Q 40/02

(52) U.S. Cl. CPC G06Q 40/025

(57) ABSTRACT

Systems and methods for loan underwriting for prepaid accounts in accordance with embodiments of the invention are disclosed. In one embodiment, a method for processing transactions includes obtaining transaction data using an account servicing server system, wherein the transaction data includes price data and metadata identifying a consumer account, obtaining product account data based on the metadata using the account servicing server system, wherein the product account data includes account balance data describing the funds available, calculating loan risk data based on the transaction data and the product account data using the account servicing server system, determining loan eligibility data based on the calculated loan risk data using the account servicing server system, generating transaction approval data based on the loan eligibility data and the transaction data using the account servicing server system, and providing the transaction approval data using the account servicing server system.

### CROSS-REFERENCE TO RELATED APPLICATIONS

The current application claims priority to U.S. Provisional Patent Application Ser. No. 62/098,995, filed Dec. 31, 2014, the disclosure of which is hereby incorporated by reference in its entirety.

### FIELD OF THE INVENTION

The present disclosure relates generally to financial services systems, and relates, more particularly, to underwriting loans based on financial transactions.

### BACKGROUND

The financial services industry provides a plethora of financial services to consumers for managing their finances and engaging in financial transactions with retailers and service providers. Consumers may hold funds within many different types of accounts at many different types of financial institutions. Consumers may access the funds held in the accounts using many different types of cards, including credit cards, debit cards, gift cards, and other types of cards based on the particular type of account associated with the card. The cards may be issued from financial institutions, such as banks, credit unions, savings & loans, and brokerage institutions.

A payment processor is a company that handles transactions for one or more financial institutions. Many payment processors have connections to various card associations and supply authorization and settlement services to the financial institutions. Several payment processors facilitate the movement of funds between payment processors and financial institutions. Payment processors verify aspects of proposed transactions. Once the payment processor has received confirmation or denial of the verification, the information can be relayed to the financial institution that can then complete or invalidate the payment transaction accordingly.

### SUMMARY OF THE INVENTION

Systems and methods for loan underwriting for prepaid accounts in accordance with embodiments of the invention are disclosed. In one embodiment, a method for processing transactions includes obtaining transaction data using an account servicing server system, wherein the transaction data includes price data and metadata identifying a consumer account, obtaining product account data based on the metadata using the account servicing server system, wherein the product account data includes account balance data describing the funds available, calculating loan risk data based on the transaction data and the product account data using the account servicing server system, determining loan eligibility data based on the calculated loan risk data using the account servicing server system, generating transaction approval data based on the loan eligibility data and the transaction data using the account servicing server system, and providing the transaction approval data using the account servicing server system.

In an additional embodiment of the invention, the transaction approval data is provided to a payment processor system using the account servicing server system.

In another embodiment of the invention, the transaction approval data includes a request to re-execute the transaction data.

In yet another additional embodiment of the invention, the transaction approval data includes metadata describing an authorization to allow an overage on the financial transaction based on the offer data.

In still another additional embodiment of the invention, the transaction data is obtained from a payment processor system.

In yet still another additional embodiment of the invention, the method further includes transmitting deposit data to a financial institution system holding the consumer account using the account servicing server system, wherein the deposit data includes an amount of money to be deposited into the account based on the loan eligibility data.

In yet another embodiment of the invention, the method further includes identifying a client device associated with the consumer account using the account servicing server system, and transmitting notification data to the client device using the account servicing server system, wherein the notification data includes the loan eligibility data.

In still another embodiment of the invention, the method further includes obtaining loan acceptance data from the client device using the account servicing server system and providing the transaction approval data in response to obtaining the loan acceptance data using the account servicing server system.

In yet still another embodiment of the invention, the product account data further includes a set of historical account balance values and the loan eligibility data is based on an average daily value of the consumer account calculated based on the set of historical account balance values using the account servicing server system.

In still another embodiment of the invention, the loan risk data is calculated by obtaining risk model data comprising a set of risk determination criteria and operations for calculating risk based on a set of input data and calculating a risk score for the obtained transaction data using the risk model data and the loan eligibility data is determined by calculating a business risk score using a set of business rule data and the calculated risk score and determining if the calculated business risk score exceed a risk threshold value.

In yet another additional embodiment of the invention, the product account data further includes a set of historical reload data describing when funds were loaded on to the consumer account and the value of the reloads and the loan eligibility data is based on an average reload value calculated based on the set of historical reload data using the account servicing server system.

Still another embodiment of the invention includes an account servicing server system including a processor and a memory connected to the processor and storing an account servicing application, wherein the account servicing application directs the processor to obtain transaction data including price data and metadata identifying a consumer account, obtain product account data including account balance data describing the funds available, calculate loan risk data based on the transaction data and the product account data, determine loan eligibility data based on the calculated loan risk data, generate transaction approval data based on the loan eligibility data and the transaction data, and provide the transaction approval data.

In yet another additional embodiment of the invention, the transaction approval data is provided to a payment processor system.

In still another additional embodiment of the invention, the transaction approval data includes a request to re-execute the transaction data.

In yet still another additional embodiment of the invention, the transaction approval data includes metadata describing an authorization to allow an overage on the financial transaction based on the offer data.

In yet another embodiment of the invention, the transaction data is obtained from a payment processor system.

In still another embodiment of the invention, the account servicing application further directs the processor to transmit deposit data to a financial institution system holding the consumer account and the deposit data includes an amount of money to be deposited into the account based on the loan eligibility data.

In yet still another embodiment of the invention, the account servicing application further directs the processor to identify a client device associated with the consumer account, and transmit notification data to the client device, wherein the notification data includes the loan eligibility data.

In yet another additional embodiment of the invention, the account servicing application further directs the processor to obtain loan acceptance data from the client device and provide the transaction approval data in response to obtaining the loan acceptance data.

In still another additional embodiment of the invention, the product account data further includes a set of historical account balance values and the loan eligibility data is based on an average daily value of the consumer account calculated based on the set of historical account balance values using the account servicing server system.

In yet another embodiment of the invention, the loan risk data is calculated by obtaining risk model data comprising a set of risk determination criteria and operations for calculating risk based on a set of input data and calculating a risk score for the obtained transaction data using the risk model data and the loan eligibility data is determined by calculating a business risk score using a set of business rule data and the calculated risk score and determining if the calculated business risk score exceed a risk threshold value.

In yet still another additional embodiment of the invention, the product account data further includes a set of historical reload data describing when funds were loaded on to the consumer account and the value of the reloads and the loan eligibility data is based on an average reload value calculated based on the set of historical reload data using the account servicing server system.

### BRIEF DESCRIPTION OF THE DRAWINGS

FIG. 1 is a conceptual illustration of an account servicing system in accordance with an embodiment of the invention.

FIG. 2 is a conceptual illustration of an account servicing server system in accordance with an embodiment of the invention.

FIG. 3A is a flow chart illustrating a process for fulfilling a transaction in accordance with an embodiment of the invention.

FIG. 3B is a flow chart illustrating a process for fulfilling a transaction using a line of credit in accordance with an embodiment of the invention.

FIG. 4A is a flow chart illustrating a process for underwriting a loan in accordance with an embodiment of the invention.

FIG. 4B is a flow chart illustrating a process for underwriting a loan with shared risk in accordance with an embodiment of the invention.

FIG. 5 is a flow chart illustrating a process for fraud detection in accordance with an embodiment of the invention.

FIG. 6 is a flow chart illustrating a process for creating loan underwriting and fraud detection models in accordance with an embodiment of the invention.

### DETAILED DESCRIPTION

Turning now to the drawings, systems and methods for loan underwriting for prepaid accounts in accordance with embodiments of the invention are disclosed. Prepaid accounts allow consumer accounts to easily have access to funds that have been deposited to their prepaid account without the overhead of a traditional financial institution. Prepaid cards allow consumers to load funds onto their consumer accounts associated with the prepaid card (i.e. a prepaid card account) at a variety of participating locations, such as retailers. Funds can be loaded onto a prepaid card (i.e. deposited into the consumer account associated with the prepaid card) through various mechanisms, including direct-deposit, check deposit, wire transfers, online deposits, cash deposits, and any other techniques as applicable to the requirements of specific embodiments of the invention. Consumers can then use the prepaid cards in a manner similar to traditional debit and/or credit cards to purchase products using the funds that have been loaded onto the account. However, many consumer accounts (particularly those associated with sub-prime consumers) do not have sufficient funds in order to purchase the products in a particular transaction. By extending a loan to these consumer accounts, prepaid cards can be utilized to complete these transactions even when insufficient funds are present. Any of a variety of loans can be extended in accordance with the requirements of specific applications of the invention including, but not limited to, unsecured loans, secured loans, and installment (e.g. closed-ended) loans. The particular loan product(s) extended to a consumer account can depend on any of a variety of factors such as, but not limited to, the amount of the loan offered, the amount of security associated with the consumer account, the recency of the last loan offered, accepted, and/or paid off by the consumer account, the amount of loans previously offered and/or outstanding, the products being purchased, demographic information describing the consumer account, the balance history of the account, and any other data as appropriate to the requirements of specific applications of embodiments of the invention. In particular, loans can be offered when prepaid cards are utilized to purchase goods at both brick and mortar retail locations and online marketplaces. Furthermore, multiple payment methods can be utilized in a single transaction. Payment methods include cash, check, prepaid card, loan (e.g. credit), and any other payment method as appropriate to the requirements of specific applications of embodiments of the invention.

Account servicing systems in accordance with a variety of embodiments of the invention allow consumer accounts to identify particular products that they wish to purchase. In many embodiments, the account servicing systems facilitate the purchase of the products by underwriting loans. When a consumer uses the prepaid card to purchase the identified product, the funds to purchase the product can then be taken from both the consumer account and/or the loan as appropriate to the particular transaction being executed. As an illustration, if a consumer account has identified a product that costs $100 and has $80 in a consumer account, a loan can be offered to the consumer account that would make up the $20 difference and allow the consumer account to purchase the identified product. By way of a second illustration, a consumer account can have a line of credit associated with the consumer account and the loan offered can be extended based on the existing line of credit. As described in more detail below, a wide variety of data can be utilized to automatically evaluate particular accounts in order to determine if loans should be offered. In particular, as account servicing systems are capable of identifying both the loan history associated with a consumer account along with when the consumer account has available funds, account servicing systems can better underwrite loans by identifying consumer accounts that may have a poor credit history (i.e. be sub-prime candidates) but currently exhibit improved management and/or balances. Furthermore, a variety of fraud detection techniques can be incorporated into the loan underwriting process.

In numerous embodiments, underwriting loans and/or detecting fraud utilizes one or more models. These models can be used alone and/or in combination with a variety of business rules to determine if a particular loan should be underwritten. Once the models are generated, they can be utilized in a variety of ways as appropriate to the requirements of specific applications of embodiments of the invention. One way includes determining if a consumer account is eligible for credit at all. A result of the credit determination can also be provided to the consumer account. For example, a consumer account could have insufficient account age and/or insufficient activity to qualify for a loan. A second way includes using the model data to make a specific underwriting decision. For example, an underwriting decision can be made by gathering the raw data necessary to perform a particular analysis using the model data. This raw data can include properties of the consumer account and properties of the specific loan being requested. The properties can include, but are not limited to, consumer account history data, location data, proposed purchase data, and/or client devices associated with the consumer account. This data can also be transformed using a variety of processes to generate additional metadata that can be utilized by the model data using techniques described in more detail below. For example, the ratio of the requested loan amount to average consumer income in the zip code associated with the consumer account can be determined. The raw data and/or metadata can be processed using the model data to generate one or more model scores; this output can then be combined with business rule data to make a decision regarding the requested loan. This decision can include an approval, decline, request for additional information, or any other response as appropriate to the requirements of specific applications of embodiments of the invention. In many embodiments, a loan approval includes a variety of sub-responses including approving a consumer at different interest rates, terms, or for partial amounts based on the determined risk.

Systems and processes for loan underwriting and fraud detection in accordance with embodiments of the invention are described in more detail below.

### Account Servicing Systems

Conducting financial transactions can involve communication between many different parties (e.g., banks, processors, credit issuers, regulators, consumers, etc. . . . ) prior to funds being exchanged between a consumer and a retailer (i.e. between a consumer account and the retailer's account). For example, a consumer account may initiate a purchase at a point-of-sale terminal of a retailer. The retailer may track certain information for the consumer account, including the items being purchased and the total purchase price and may send this information to a third party payment processor. In turn, the payment processor can communicate with a multitude of financial systems in order to process the transaction.

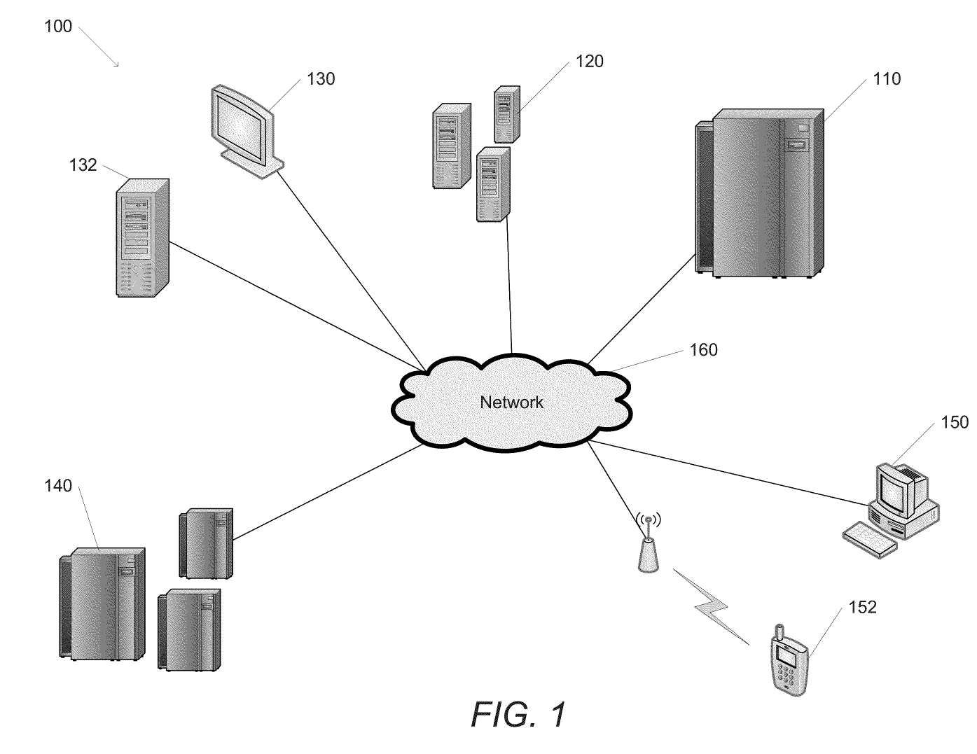

Turning now to FIG. 1, a conceptual illustration of an account servicing system in accordance with an embodiment of the invention is shown. The account servicing system 100 includes account processing server system 110, payment processor systems 120, retailer systems such as point of sale terminals 130 and retailer server system 132, financial institution systems 140, and client devices including, but not limited to, personal computers 150 and mobile devices 152. These systems communicate through one or more networks 160. Network(s) 160 can include, but are not limited to, the Internet, a local area network, a wide area network, and networks that are shared privately between only a subset of the systems. For example, the payment processor 120 can communicate with the financial institution systems 140, retailer systems, and account processing server system 110 via one or more private networks.

Account servicing server system 110 provides front-end and back-end services for creating and managing accounts for prepaid cards via a number of account servicing processes as appropriate to the requirements of specific applications of embodiments of the invention. Account servicing server system 110 can obtain account data for a prepaid card from a retailer system and/or from a user device. The account servicing server system 110 can assign the account to a payment processor system 120 and/or financial institution 140; a request that a permanent card be issued to the account holder associated with the account by the payment processor system 120 and/or financial institution 140 can also be made. The account servicing server system 110 can also communicate with the financial institution 140 and/or the payment processor system 120 to facilitate the execution of transactions between consumer accounts and retailer systems when the transaction involves the prepaid card. In many embodiments, the account servicing server system 110 includes some or all of the aspects of the payment processor systems 120 and/or the financial institution systems 140. In a number of embodiments, the retailer systems host their own account servicing server system 110.

The account servicing server system 110 can also provide an interface providing account data, user profile data, balance data, transaction data, fee data, and any other data related to the prepaid card and/or the account as appropriate to the requirements of specific applications of embodiments of the invention. In many embodiments, the consumer account provides funds (cash, check, direct deposit, etc. . . . ) to a point of sale terminal at a retailer along with a prepaid card. The retailer system can then transmit transaction data specifying the amount of funds to be added to the consumer account associated with the prepaid card to an account servicing server system, a payment processor system, and/or a financial institution system as appropriate to the requirements of specific applications of embodiments of the invention. When a transaction is executed, the account servicing server system 110 can obtain transaction data describing the transaction, including the amount to be debited as a result of the transaction and/or the status (i.e. approved, denied) of the transaction. By way of example, transaction data can be transmitted to a payment processor system associated with the prepaid card. The payment processor system determines that insufficient funds are present in the consumer account and denies the transaction. The payment processor system can then notify the account servicing server system that a transaction has been presented and denied. In this way, the account servicing server system 110 can facilitate the purchase of products using a prepaid card by automatically granting loans in order to facilitate a transaction. In numerous embodiments, the transaction is fulfilled as a split tender transaction, with one portion of the transaction being processed directly to a line of credit extended to the consumer account and a second portion of the transaction being processed using the prepaid card account. In a variety of embodiments, the consumer account can approve a transfer of the loan funds to the prepaid card account and then complete the purchase as a prepaid transaction. In this way, loans can be extended to consumer accounts without resorting to extending overdraft protection to the consumer account.

Retailer systems, such as point of sale terminal 130, can be used to purchase prepaid cards, load fund onto the prepaid cards, as well as process transactions that use a prepaid card associated with a consumer account to make purchases of products and/or services from the retailer. The point of sale terminal 130 can transmit transaction data describing the requested transaction to the retailer server system 132 and/or the processor system 120. In many embodiments, the point of sale terminal 130 communicates directly with the account servicing system 110. In a variety of embodiments, the retailer server system 132 obtains transaction data from a number of point of sale terminals 130 and transmits the transaction data utilizing techniques similar to those described above.

Payment processor system 120 can process transactions on behalf of financial institution 140, retailer systems, card issuers, and many other types of financial institutions. In many embodiments, prepaid cards serviced by the account servicing server system 110 are associated with a particular payment processor system 120. In a variety of embodiments, the payment processor system 120 issues the prepaid cards (or any other account). Payment processor systems 120 provide a transaction interface that can be utilized to process transaction data. The transaction data can be obtained from any system, including the retailer system. In a number of embodiments, the payment processor system 120 processes transactions for prepaid cards (or any other account) issued by (or otherwise associated with) the payment processor system 120. Processing transaction data includes determining if a transaction should be authorized. If a transaction is authorized, funds drawn from an account associated with the prepaid card are directed to be transferred to an account associated with the retailer identified in the transaction. The transfer of funds can include transmitting requests to one or more financial institution systems 140 and/or the account servicing server system 110 in order to execute the requested transaction. In several embodiments, if the transaction is not authorized, the payment processor system 120 can request additional information from the account servicing server system 110. This additional information can then be utilized to re-process the transaction, potentially resulting in the transaction being authorized.

In a variety of embodiments, payment processor systems 120 provide one or more account servicing interfaces to communicate with the account servicing server system 110 and/or financial institution system 140. The account servicing interface can be utilized by the account servicing server system 110 to obtain and/or transmit data to and from the payment processor system 120. For example, requests to issue accounts can be obtained using the account servicing interface. Similarly, if the payment processor system 120 needs additional information in order to process a transaction, that information can be requested and obtained from the account servicing server system 110 and/or the financial institution system 140. However, it should be noted that any processes that include communication between the payment processor system 120 and other systems within the account servicing system 100 can utilize the account servicing interface as appropriate to the requirements of specific embodiments of the invention.

Financial institution systems 140 include financial accounts for one or more entities. These financial accounts hold funds on behalf of the entities and can transfer the funds to retailer systems, payment processors, account servicing server systems, or any other system as appropriate to the requirements of specific applications of embodiments of the invention. In many embodiments, financial institution systems 140 incorporate some or all aspects of the payment processor systems 120. In this way, financial institution systems can issue, service, and/or approve transactions related to prepaid cards.

Client devices can be used to manage account data associated with prepaid cards, purchase cards, add (e.g. reload) or remove funds from cards, purchase products from a retailer, request and/or accept loans, and any other transactions or operations as appropriate to the requirements of specific applications of embodiments of the invention. Furthermore, client devices can obtain and display notifications transmitted to the device via any of a variety of techniques, including, but not limited to, on a request for advertising data, push notifications, email, short message service (SMS) messages, multimedia message service (MMS) messages. Client devices can also identify one or more products and create a product account that holds funds dedicated toward purchasing the identified product(s). In a variety of embodiments, the product accounts are described using product account data that can be referenced by and/or included in the account data. In several embodiments, the advertising data describes discounts (i.e. coupons) and/or promotions associated with one or more products described using the product account data. When the prepaid card associated with the account data is utilized to purchase the products associated with the product account data, the account servicing server system 110 provides (or causes to be provided by the payment processor system 120 and/or the financial institution 140) the necessary funds using the product account and/or the coupon described by the advertising data. In this way, offer data can be utilized to augment loan underwriting processes.

Although a specific architecture of an account servicing system in accordance with embodiments of the invention are discussed above and illustrated in FIG. 1, a variety of architectures, including user devices not specifically named and account servicing server systems that incorporate aspects of payment processor systems and/or financial institution systems, can be utilized in accordance with embodiments of the invention. Furthermore, it should be noted that any data created and/or transferred within the system can be provided by any system in any manner (i.e. via one or more application programming interfaces (APIs) web services, and/or file-based interfaces) as appropriate to the requirements of specific applications of embodiments of the invention.

### Account Servicing Server Systems

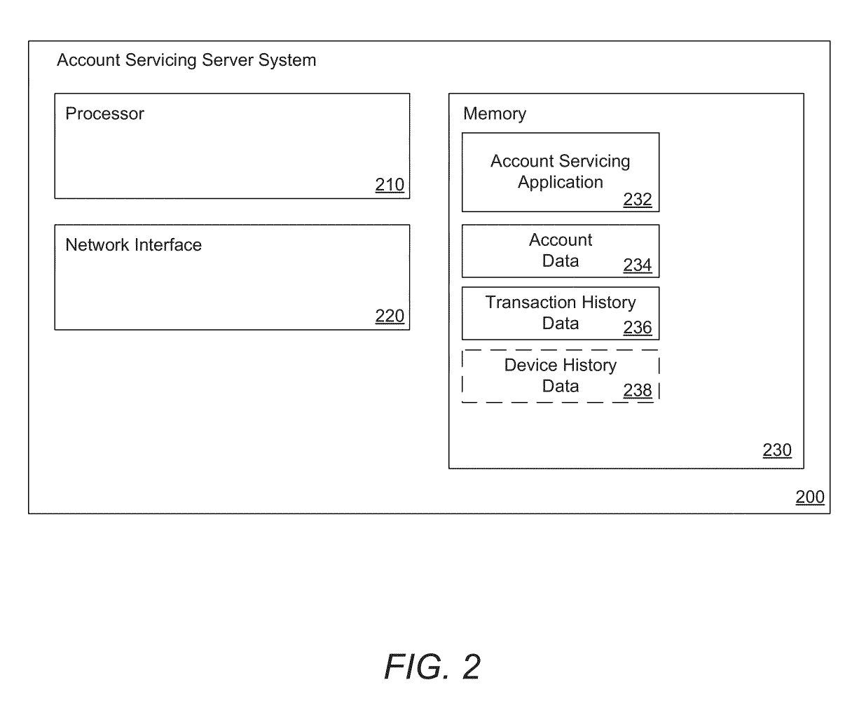

As described above, account servicing server systems can provide a variety of services for prepaid cards. One of these services includes extending loans to eligible consumer accounts. An account servicing server system in accordance with an embodiment of the invention is conceptually illustrated in FIG. 2. The account servicing server system 200 includes a processor 210 in communication with a network interface 220 and a memory 230. The network interface 220 is configured to send and receive data over a network connection. In a number of embodiments, the network interface 220 is in communication with the memory 230. In several embodiments, memory 230 is any form of storage configured to store a variety of data, including, but not limited to, an account servicing application 232, account data 234, transaction history data 236, and in a variety of embodiments, device history data 238.

The account servicing application directs the processor 210 to perform a variety of account servicing processes. The account servicing processes include processing financial transactions for a consumer account, including reconciliation of debits and credits applied to a consumer account. The account servicing processes can also include managing account data 234 describing the consumer account including, but not limited to, reload activity, balance activity, and location data, consumer account profile data, demographic data, employment information, credit status, income, mailing address, and/or any other consumer account pertinent information. Account data 234 can include data received from a variety of different sources, including client devices, retailer systems, payment processor systems, financial institution systems, and any other of a variety of other sources. Furthermore, the account data 234 can be related to transaction history 236. Transaction history 236 can include purchase history, credits and deposits, available balance, retailer data, product data including a variety of category data describing the category associated with a target product and/or a set of attribute/value pairs that describe the product, among any other information as appropriate to the requirements of specific applications of the invention. Device history data can include, but is not limited to, client devices associated with the account data 234, location data describing the location of a client device when a prepaid card was used, and any other data as appropriate to the requirements of specific applications of embodiments of the invention.

Although a specific architecture for an account servicing server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 220 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. A variety of account servicing processes in accordance with embodiments of the invention are discussed further below.

### Fulfilling Transactions

Prepaid cards to purchase a wide variety of products and services using funds deposited into an associated consumer account. However, in order to successfully complete a transaction, the consumer account must have sufficient funds in order to cover the cost of the products being purchased. In several embodiments, account servicing processes include automatically extending loans in order to provide sufficient funds to complete a transaction. As such, the consumer account can simply purchase items using their prepaid card; the loan can be automatically underwritten and granted. Similarly, consumer accounts can opt-in to accept a short-term loan via a client device. In numerous embodiments, a consumer account can opt to draw funds from a line of credit associated with the consumer account.

A number of techniques can be utilized to automatically transfer funds to a consumer account as appropriate to the requirements of specific applications of embodiments of the invention. As a first example, the financial institution system can maintain a set of loan rules for a particular consumer account. Upon receipt of transaction data instructing the financial institution system to withdraw funds from the consumer account, the financial institution system can withdraw a first portion of the funds from the consumer account and a second portion can be provided by a loan. As a second example, the distribution of the loan can be handled by the account servicing server system. Upon receiving the transaction data to withdrawn funds from the consumer account, the account servicing server system can generate a first withdraw transaction to withdraw a first portion of the funds from the consumer account and generate a second withdraw transaction to transmit a second portion of the funds via a loan. Both the first deposit transaction data and the second deposit transaction data can then be transmitted to the financial institution system for execution. Similarly, the account servicing server system can automatically determine the loan amount and then transmit the necessary funds to the financial institution system to be deposited in to the consumer account. In numerous embodiments, the loan funds are drawn from a line of credit associated with the consumer account. The account servicing system can then request that the transaction be re-processed (or a new transaction be executed) by the payment processor system as the necessary funds are now present as appropriate to the requirements of specific applications of embodiments of the invention. It should be noted that any flow of funds and transaction data between the account servicing server system, payment processor system, and/or financial institution system can be utilized to extend loans and authorize transactions as appropriate to the requirements of specific applications of embodiments of the invention. In particular, a variety of conditions can be set in order to determine when a loan should be taken to fulfill a particular transaction. For example, a loan can be taken if a transaction would take the balance of the consumer account below a pre-set amount and/or leave the account unable to make other scheduled payments.

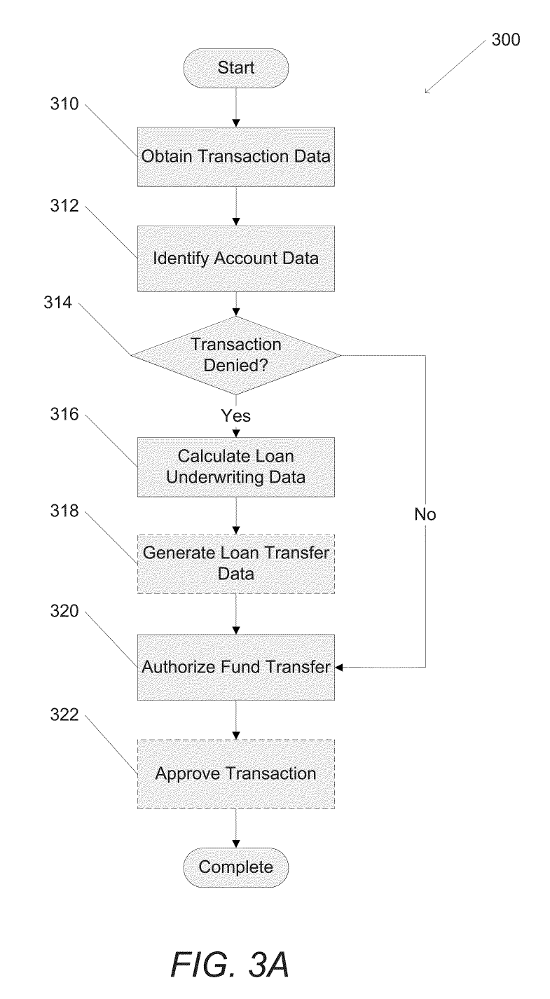

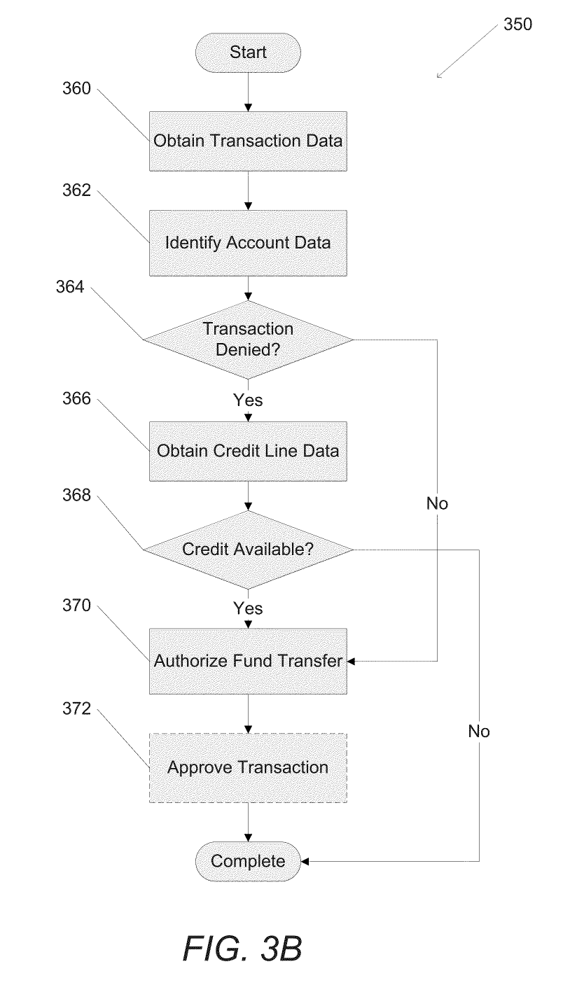

A process for fulfilling transactions in accordance with embodiments of the invention is shown in FIG. 3A. The process 300 includes obtaining (310) transaction data and identifying (312) a consumer account. If the transaction data indicates that the transaction has been denied (314), loan underwriting data is calculated (316) and loan transfer data can be generated (318). A fund transfer is authorized (320) and the transaction can be approved (322). If the transaction data indicates that the transaction has not been denied (314), the fund transfer can be authorized (320).

A process for fulfilling transactions using a line of credit in accordance with an embodiment of the invention is shown in FIG. 3B. The process 350 includes obtaining (360) transaction data and identifying (362) account data. If a transaction is denied (364), credit line data is obtained (366) and, if credit is available (368), a fund transfer is authorized (370). In a variety of embodiments, a transaction is approved (372). If a transaction is not denied (364), a funds transfer can be authorized (370). If credit is not available (368), the process completes.

Specific process for fulfilling transactions in accordance with embodiments of the invention are described above; however, any number of processes, including those that mark offers as redeemed and those that apply offers to transactions utilizing techniques other than those specifically described above, can be utilized as appropriate to the requirements of specific applications in accordance with embodiments of the invention.

### Loan Underwriting

Consumer accounts who utilize prepaid cards are often considered sub-prime candidates for obtaining loans through traditional financial institutions. As such, these consumer accounts are frequently unable to obtain loans. However, by taking advantage of the data available by a consumer use of a prepaid card, a more rigorous analysis of the consumer creditworthiness can be performed. Account servicing processes in accordance with embodiments of the invention include underwriting loans for eligible consumer accounts. Prepaid cards provide a robust account history including a wide variety of financial data including, but not limited to, balance activity, reload activity (i.e. when the consumer account loads funds onto the prepaid card), location data regarding where funds are loaded and spent, the time the consumer account has been open, direct deposit status data, and/or bill pay status data (i.e. if the prepaid card is used to automatically pay bills issued by third parties). In several embodiments, the account history data further includes historical transaction data describing products and/or services purchased using the prepaid card. The historical transaction data can include, but is not limited to, location data regarding where the products were purchased, price information, offers utilized, retailer information, and product data including category data and/or attribute/value pairs describing the products.

Account history data can also include advertisements and/or offers that have been accepted by a consumer account. The applicability of an offer to a particular transaction can be a mitigating factor when determining the risk associated with extending a loan. For example, if a consumer account needs $5 to complete a transaction but has an offer to deduct $10 from the transaction, the loan for $5 should be approved as $10 will be redeemable as soon as the transaction is completed. Systems and methods for identifying, accepting, and redeeming offers in prepaid card transactions that can be utilized in accordance with embodiments of the invention are described in U.S. patent application Ser. No. 14/587,945, filed Dec. 31, 2014, the entirety of which is hereby incorporated by reference in its entirety. Additionally, many prepaid cards are associated with multiple accounts, including target product accounts that are used to save money toward the purchase of a particular target product. The presence and/or consistent use of target product accounts to purchase products can be a factor used in the calculating the risk of extending a loan. Systems and methods for conducting transactions for target products using prepaid cards that can be utilized in accordance with embodiments of the invention are described in U.S. patent application Ser. No. 14/587,931, filed Dec. 31, 2014, the entirety of which is hereby incorporated by reference in its entirety. For example, if an offer was presented to a consumer account for 25% off a television purchased at Retailer A available for the next 3 days, the process would include determining whether any transactions occurred at Retailer A for the particular type of television during the specified period. In a number of embodiments, the process can add funds to the consumer card account based on the offer criteria. In a variety of embodiments, the retailer system can be notified to discount the item at the time of purchase. In many embodiments, a payment processor system is instructed to authorize a transaction exceeding the balance available on the prepaid card by the amount of the offer. By automatically redeeming offers and applying offers to consumer account transactions, loans can be successfully underwritten while taking on very little risk.

Loan risk data can be calculated based on any combination and/or weighting of any of the data described above. For example, the average monthly balance for a prepaid card can be calculated and the loan risk associated with the loan can be based on the amount of the loan as compared to the average monthly balance. It should be noted that the average balance can be calculated over any arbitrary time period, such as one day, three days, seven days, etc. . . . By way of a second example, the average reload amount can be calculated and the loan risk associated with the loan can be based on the amount of the loan as compared to the average reload amount. Furthermore, a determination regarding the account and/or transaction can be made with respect to potential fraudulent activity. Processes for determining fraud risk scores that can be utilized in accordance with embodiments of the invention are described in more detail below. Furthermore, the loan risk data can be calculated based on the amount of the loan being extended. In particular, smaller loans are generally less risky than larger loans.

Additionally, in many embodiments, retailer systems can participate in the loan underwriting process. In a number of embodiments, retailer systems provide loan underwriting rule data to an account servicing server system. The loan underwriting rule data can then be utilized to identify particular (classes of) consumer accounts and/or products to which the retailer desires to extend loans and/or the amount of loan the retailer system is willing to risk. In this way, account servicing server systems and retailer systems can share in the risk associated with a particular loan. This can allow for more loans and/or larger loans to be offered. Similarly, by utilizing a prepaid card, specific loans can be offered to consumer accounts that are not generally available. For example, a car dealership can offer a loan on a particular automobile to consumers willing to use a prepaid card to complete the transaction. In this way, retailer systems can subsidize loans on prepaid card accounts in order to drive additional business to the retailer.

Any of the above criteria can be combined and/or weighted in order to determine loan eligibility data describing if the loan should be approved. The loan eligibility data can be any data, such as a score, an approved/denied flag, or any other expression of the result of the loan underwriting process. In several embodiments, the loan eligibility data can be provided to a variety of third-party services. In this way, a database of the determined loan eligibility data can be published.

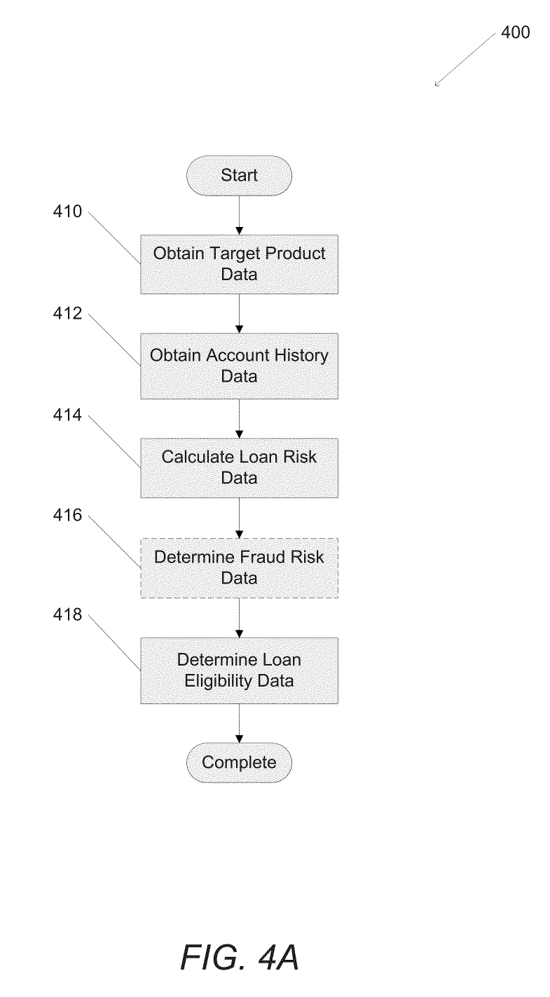

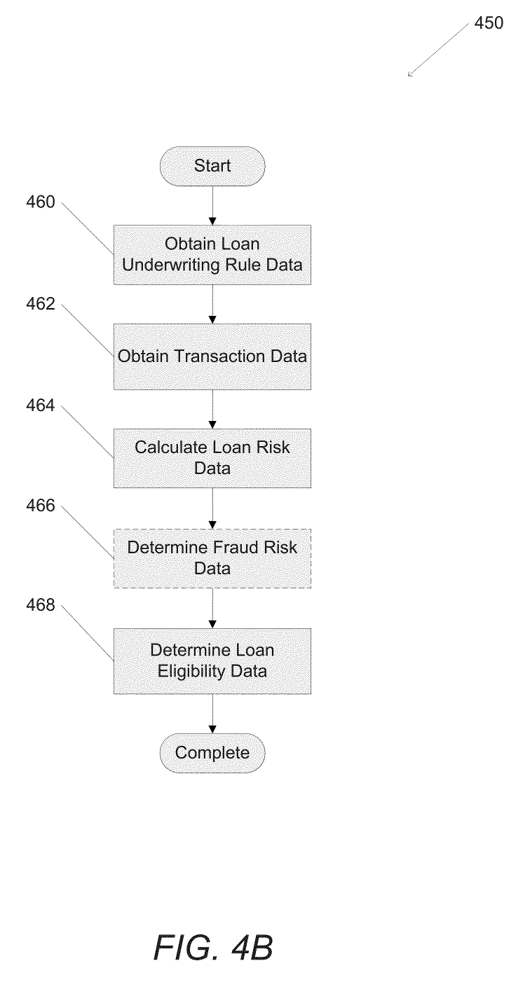

A process for loan underwriting in accordance with an embodiment of the invention is shown in FIG. 4A. The process 400 includes obtaining (410) target product data, obtaining (412) account history data, calculating (414) loan risk data, and in many embodiments, determining (416) fraud risk data. Loan eligibility data is determined (418). Turning now to FIG. 4B, a process for loan underwriting with shared risk in accordance with an embodiment of the invention is shown. The process 450 includes obtaining (460) loan underwriting rule data, obtaining (462) transaction data, calculating (464) loan risk data, and, in several embodiments, determining (466) fraud risk data. Loan eligibility data is determined (468).

Although specific processes for loan underwriting in accordance with embodiments of the invention are described above, any number of processes, including those that utilize additional factors to underwrite a loan and those that include the financial institution systems in the sharing of loan risk, either with or without the retailer systems, can be utilized as appropriate to the requirements of specific applications in accordance with embodiments of the invention.

### Fraud Detection

When extending loans to consumer accounts, it is important to identify those consumer accounts that are likely to repay the loans. However, even if a consumer account appears to be creditworthy, it is possible that prepaid cards and/or client devices associated with the consumer account have been compromised. This could allow an adverse party to obtain loans to be used for nefarious purposes. In many embodiments, account servicing processes include analyzing a proposed transaction and/or account transaction history to identify potential fraud. A fraud risk score can be calculated based on a variety of criteria, including demographic information related to the account, the transaction history associated with the account, the proposed transaction to be executed, location data, device data, and any of a variety of other data as appropriate to the requirements of specific applications of embodiments of the invention.

Demographic information can be utilized to identify transactions that are inconsistent with expected purchases. Location data can be used to determine where a prepaid card is normally used—purchases far from a usual location or indicating rapid (potentially impossibly so) travel can be indicative of fraud. Transaction data, including historical transaction data, can be utilized to identify products and/or services regularly purchased along with retailers associated with the prepaid card. Purchases outside of the standard can be indicative of fraud. In many embodiments, one or more client devices are associated with a prepaid card. However, most client devices are only associated with a single consumer account. In numerous embodiments, a particular consumer may only have a single active consumer account, even if the consumer has previously opened a number of consumer accounts over the years. If a particular client device is associated with multiple consumer accounts, fraud could be indicated. Additionally, the phone number and/or carrier associated with a client device can be utilized, as certain geographic locations and/or carriers are more likely to be utilized in fraudulent situations. Any of the above criteria can be combined and/or weighted in order to calculate a fraud risk score. In several embodiments, the fraud risk scores can be provided to a variety of third-party services. In this way, a database of the calculated fraud risk scores can be published.

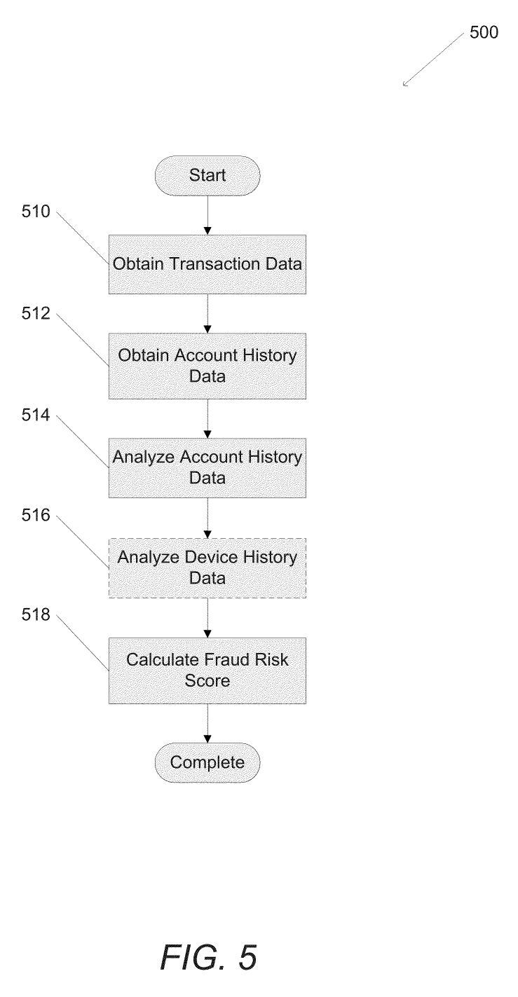

A process for fraud detection in accordance with embodiments of the invention is shown in FIG. 5. The process 500 includes obtaining (510) transaction data, obtaining (512) account history data, analyzing (514) account history data, and in a number of embodiments, analyzing (516) device history data. A fraud risk score is calculated (518). Specific process for fraud detection in accordance with embodiments of the invention are described above; however, any number of processes, including those that utilize other techniques for expressing the fraud risk associated with a transaction, can be utilized as appropriate to the requirements of specific applications in accordance with embodiments of the invention.

### Generating Loan Underwriting and Fraud Detection Models

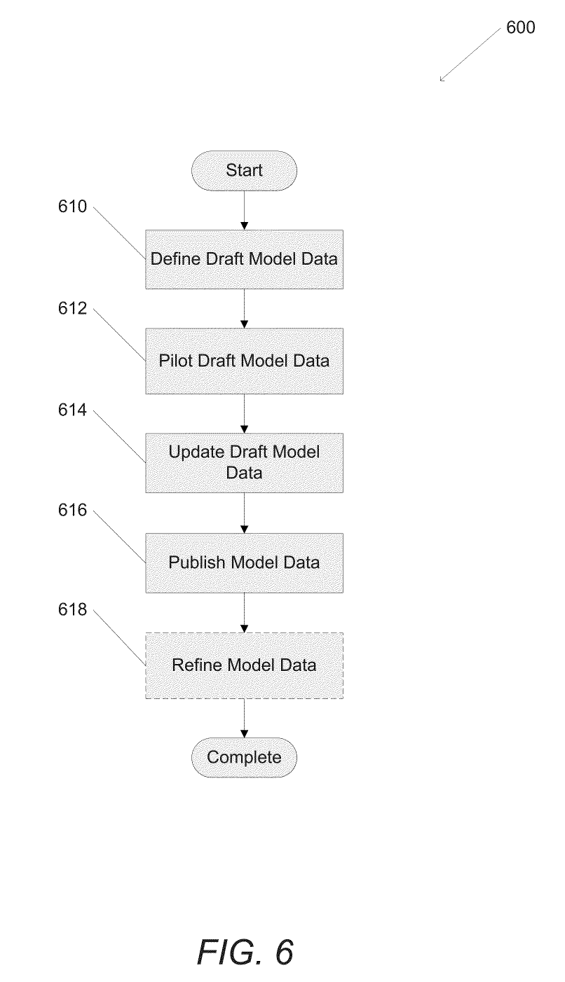

A variety of models can be generated and utilized to underwrite loans and detect fraud as appropriate to the requirements of specific applications of embodiments of the invention. A process for creating models that can be utilized to underwrite loans and/or detect fraud in accordance with an embodiment of the invention is shown in FIG. 6. The process 600 includes defining (610) draft model data, piloting (612) the draft model data with a set of training consumer accounts, updating (614) draft model data based on results of the pilot, and publishing (616) model data for general use. In a variety of embodiments, the model data can be refined (618). The creation and/or refinement of model data can iterate for the lifetime of the use of the model data. In several embodiments, patterns of fraudulent activity tend to change very quickly and so the processes can be performed on a much quicker timescale with less pilot testing and more experimentation in production.

In many embodiments, loan underwriting processes and/or fraud detection processes utilize a variety of risk determination models along with a set of business rules in order to determine if a loan and/or line of credit should be extended to a particular consumer account. Independent of how the model data (i.e. risk determination criteria along with operations for calculating risk for a given set of data) assesses the risk or future revenue potential associated with a consumer account, business rule data can be modified based on a tolerance for risk, experienced losses (globally and/or with respect to a particular consumer account), changing consumer trends, and/or the pricing for the loan product offered in order to adjust the amount of risk incurred by offering a particular loan. In this way, account servicing systems can dynamically adjust the risk associated with underwritten loans to strike a balance between potential revenue and losses. The risk score generated by the model data can be expressed in any of a variety of ways, including binary flags and/or risk scores, as appropriate to the requirements of specific embodiments of the invention. Similarly, a variety of business risk scores (or any other expression of the calculated risk) can be calculated using the business rule data.

In many embodiments, raw data includes transaction data for one or more consumer accounts. Any combination of consumer accounts available to an account servicing system including, but not limited to, all consumer accounts, a random subset of consumer accounts, consumer accounts within a particular geographic area, consumer accounts within a particular income range, consumer accounts having a certain amount of activity (or lack thereof), and/or consumer accounts having particular demographic characteristics can be utilized to source the raw transaction data as appropriate to the requirements of specific applications of embodiments of the invention.

Building draft model data can include assembling available raw data and filtering it to remove outliers, noisy data points, and/or incomplete data. Additionally, some or all of the raw data can be aggregated into a single pieces of metadata (e.g. presence of a purchase over $100 with a particular prepaid card within 10 miles of account address indicated that the consumer account has purchased groceries). In several embodiments, some or all of the raw data can be transformed into metadata that could be more predictive such as, but not limited to, calculating the square of the user's daily average balance, the ratio of deposits to purchases in the past 15 days, and any other data transformation (i.e. calculation) as appropriate to the requirements of specific applications of embodiments of the invention. The raw data and/or generated metadata can be provided to one or more classifiers to process the raw data and identify particular features within the raw data and/or metadata. The identified features can vary by the needs of a particular lending/fraud detection scenario and include, but are not limited to, minimizing loss associated with underwriting a loan, maximizing the approval rate for underwritten loans, and optimizing for total lifetime value of a consumer account (and/or class of consumer account). The model data can be validated in a number of different ways as appropriate to the requirements of specific applications of embodiments of the invention such as, but not limited to, checking the performance of the model data on a set of validation data separate from the raw data and verifying performance of the model data using updated data.

In many embodiments, when a new class of model is being generated for a particular set of consumer behaviors (i.e. behaviors determined based on the transaction data associated with a consumer account), and insufficient data could exist for a particular consumer behavior. In these cases, proxy behaviors can be determined and utilized to create the particular model data. For example, if a new loan product is to be offered and the desired consumer behavior is the repayment rate for the loan product, this data cannot exist in the raw data because the loan product did not previously exist. In this example, assuming the raw data can be utilized to determine overall consumer risk behavior, the overall consumer risk behavior can be utilized as a proxy behavior in the generation of the model data. As additional raw data is generated and the desired consumer behavior can be identified, the use of overall consumer risk behavior data in the model can be reduced and/or eliminated as the repayment rate data is introduced into the process.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for processing transactions, comprising:
obtaining transaction data using an account servicing server system, wherein the transaction data comprises price data and metadata identifying a consumer account;
obtaining product account data based on the metadata using the account servicing server system, wherein the product account data comprises account balance data describing the funds available;
calculating loan risk data based on the transaction data and the product account data using the account servicing server system;
determining loan eligibility data based on the calculated loan risk data using the account servicing server system;
generating transaction approval data based on the loan eligibility data and the transaction data using the account servicing server system; and
providing the transaction approval data using the account servicing server system.

2. The method of claim 1, wherein the transaction approval data is provided to a payment processor system using the account servicing server system.

3. The method of claim 2, wherein the transaction approval data comprises a request to re-execute the transaction data.

4. The method of claim 2, wherein the transaction approval data comprises metadata describing an authorization to allow an overage on the financial transaction based on the offer data.

5. The method of claim 1, wherein the transaction data is obtained from a payment processor system.

6. The method of claim 1, further comprising transmitting deposit data to a financial institution system holding the consumer account using the account servicing server system, wherein the deposit data comprises an amount of money to be deposited into the account based on the loan eligibility data.

7. The method of claim 1, wherein:
the method further comprises identifying a client device associated with the consumer account using the account servicing server system; and
transmitting notification data to the client device using the account servicing server system, wherein the notification data comprises the loan eligibility data.

8. The method of claim 7, further comprising:
obtaining loan acceptance data from the client device using the account servicing server system; and
providing the transaction approval data in response to obtaining the loan acceptance data using the account servicing server system.

9. The method of claim 1, wherein:
the loan risk data is calculated by:
obtaining risk model data comprising a set of risk determination criteria and operations for calculating risk based on a set of input data; and
calculating a risk score for the obtained transaction data using the risk model data; and
the loan eligibility data is determined by:
calculating a business risk score using a set of business rule data and the calculated risk score; and
determining if the calculated business risk score exceed a risk threshold value.

10. The method of claim 1, wherein:
the product account data further comprises a set of historical reload data describing when funds were loaded on to the consumer account and the value of the reloads; and
the loan eligibility data is based on an average reload value calculated based on the set of historical reload data using the account servicing server system.

11. An account servicing server system, comprising:
a processor; and
a memory connected to the processor and storing an account servicing application;
wherein the account servicing application directs the processor to:
obtain transaction data comprising price data and metadata identifying a consumer account;
obtain product account data comprising account balance data describing the funds available;
calculate loan risk data based on the transaction data and the product account data;
determine loan eligibility data based on the calculated loan risk data;
generate transaction approval data based on the loan eligibility data and the transaction data; and
provide the transaction approval data.

12. The system of claim 11, wherein the transaction approval data is provided to a payment processor system.

13. The system of claim 12, wherein the transaction approval data comprises a request to re-execute the transaction data.

14. The system of claim 12, wherein the transaction approval data comprises metadata describing an authorization to allow an overage on the financial transaction based on the offer data.

15. The system of claim 11, wherein the transaction data is obtained from a payment processor system.

16. The system of claim 11, wherein:
the account servicing application further directs the processor to transmit deposit data to a financial institution system holding the consumer account; and
the deposit data comprises an amount of money to be deposited into the account based on the loan eligibility data.

17. The system of claim 11, wherein the account servicing application further directs the processor to:
identify a client device associated with the consumer account; and
transmit notification data to the client device, wherein the notification data comprises the loan eligibility data.

18. The system of claim 17, wherein the account servicing application further directs the processor to:
obtain loan acceptance data from the client device; and
provide the transaction approval data in response to obtaining the loan acceptance data.

19. The system of claim 11, wherein:
the loan risk data is calculated by:
obtaining risk model data comprising a set of risk determination criteria and operations for calculating risk based on a set of input data; and
calculating a risk score for the obtained transaction data using the risk model data; and
the loan eligibility data is determined by:
calculating a business risk score using a set of business rule data and the calculated risk score; and
determining if the calculated business risk score exceed a risk threshold value.

20. The system of claim 11, wherein:
the product account data further comprises a set of historical reload data describing when funds were loaded on to the consumer account and the value of the reloads; and
the loan eligibility data is based on an average reload value calculated based on the set of historical reload data using the account servicing server system.
